(19) United States
(12) Patent Application Publication
(10) Pub. No.: US 2015/0295944 A1
(43) Pub. Date: Oct. 15, 2015

(54) CONTROL SYSTEM, CONTROL METHOD, AND CONTROLLER

(71) Applicant: HITACHI, LTD., Tokyo (JP)

(72) Inventors: Shoji Yunoki, Tokyo (JP); Tsutomu Yamada, Tokyo (JP); Yoshinori Okura, Tokyo (JP)

(21) Appl. No.: 14/371,253

(22) PCT Filed: Jul. 1, 2013
(86) PCT No.: PCT/JP2013/067970

§ 371 Date: Jul. 9, 2014

(51) Int. Cl. H04L 29/06; G06F 21/56

(52) U.S. Cl. CPC H04L 63/145; G06F 21/56

(57) ABSTRACT

In case a security abnormality has been detected in a control system, ensuring the safety of the control system is accomplished. In a control system including field equipment that executes a controlled process and a controller that controls execution of a controlled process by the field equipment, the controller detects a security abnormality in the control system and determines and executes a security countermeasure method against the security abnormality based on a status of a controlled process when the security abnormality has been detected in the control system.

### TECHNICAL FIELD

The present invention relates to a safety controller, a safety control system, and security countermeasures methods and, in particular, to a safety controller, a safety control system, and security countermeasures methods that are applied in an industrial plant such as a rolling plant.

### BACKGROUND ART

Recently, there has been a growing trend in which a control system of a rolling plant, a chemical plant, a car manufacturing plant, a power generating system, a water supply and sewerage system, etc. is connected to a network such as the Internet, and control, maintenance, and supervision of equipment operating in the system are automatically performed via the network. Along with this situation, a security abnormality occurs even in such a control system; for example, computers, controllers, etc. operating within a plant are infected with a virus via the Internet. Consequently, not only information systems but also control systems require security countermeasures technology.

A technique concerning security countermeasures in case a security abnormality has been detected in a control system is found in Patent Literature 1. The technique described in Patent Literature 1 is to control the operation of a controller according to preconfigured processing to cope with a security abnormality detected, once having detected a security abnormality such as virus.

### CITATION LIST

### Patent Literature

### Patent Literature 1: Japanese Unexamined Patent Application Publication No. 2003-271205

### SUMMARY OF INVENTION

### Technical Problem

“Safety” is recognized as an important requirement for a control system. In case a security abnormality such as virus infection has been detected in a control system, it is necessary to execute countermeasures to prevent such security abnormality from causing a serious accident such as fire. In some type of control system, stopping a controlled process when having detected abnormality such as a security abnormality does not always lead to safety. For example, if a security abnormality has occurred in a controller that controls metal rolling, installed in the control system for a rolling plant, stopping a controlled process could cause hot metal to be rolled to run off a rolling line and result in a serious calamity such as fire. On the other hand, during maintenance work for test operation of a controlled process with no iron and steel flowing through a rolling line, stopping the controlled process when having detected an abnormality such as a security abnormality leads to ensuring security, because an operator may enter a rolling line.

Let us consider a case where the technique of Patent Literature 1 is applied to a controller that controls a rolling plant. If it is set to stop a controlled process as a security countermeasure in case of security abnormality detected, the controlled process will be stopped when a security abnormality is detected. For example, when a security abnormality has been detected during maintenance of the control system, security is ensured by stopping the controlled process. But, if a security abnormality has been detected when the control system is operating, hot metal to be rolled may run off a rolling line by stopping the controlled process and this could result in a serious calamity such as fire, and safety is impaired. Next, let us consider a case where it is set to give notice to an administrator terminal as a security countermeasure in case of security abnormality detected. If a security abnormality has been detected when the control system is operating, by giving notice to an administrator, it is possible to consider a practical countermeasure against the security abnormality, while ensuring safety. But if the control system is under maintenance, safety is not ensured because the controlled process is not stopped.

An object of the present invention intended for solving the foregoing problem is to ensure the safety of a control system in case of a security abnormality detected, taking a status of a controlled process in the control system into account.

### Solution to Problem

To achieve the above object, in one aspect of the present invention, there is provided a control system including field equipment that executes a controlled process and a controller that controls execution of the controlled process by the field equipment. The controller includes a controlled process status storing unit that stores status of a controlled process; a security countermeasures management table storing unit that stores a security countermeasures management table associating controlled process statuses and security countermeasures methods; a security abnormality detecting unit that detects a security abnormality in the control system; a security countermeasure determining unit that determines one of the security countermeasures methods based on the security countermeasures management table when a security abnormality in the control system has been detected by the security abnormality detecting function unit; and a security countermeasure executing unit that executes the security countermeasure method determined by the security countermeasure determining unit.

### Advantageous Effect of Invention

Even in case a security abnormality has occurred in a control system for a rolling plant or the like where a security countermeasure proper for a status of a controlled process is required to enhance safety, it is possible to ensure the safety of the control system.

### BRIEF DESCRIPTION OF DRAWINGS

FIG. 1 is a diagram depicting an overall structure of a control system of an embodiment disclosed herein.

FIG. 2 is a diagram depicting a structure of a field network to which a controller of an embodiment disclosed herein connects.

FIG. 3 is a block diagram depicting a controller of a first embodiment.

FIG. 4 is a diagram presenting a security countermeasures management table in the controller of the first embodiment.

FIG. 5 is a flow diagram illustrating operation of the controller of the first embodiment.

FIG. 6 is a block diagram depicting a controller of a second embodiment.

FIG. 7 is a diagram presenting a security countermeasures management table in the controller of the second embodiment.

FIG. 8 is a block diagram depicting a controller of a third embodiment.

FIG. 9 is a diagram presenting a security countermeasures management table in the controller of the third embodiment.

FIG. 10 is a block diagram depicting a controller of a fourth embodiment.

FIG. 11 is a diagram presenting a security countermeasures management table in the controller of the fourth embodiment.

FIG. 12 is a block diagram depicting a controller of a fifth embodiment.

FIG. 13 is a diagram presenting security countermeasures management tables respectively in controllers of the fifth embodiment.

FIG. 14 is a block diagram depicting a controller of a sixth embodiment.

### DESCRIPTION OF EMBODIMENTS

### First Embodiment

In the following, embodiments of the present invention will be described with the aid of the drawings.

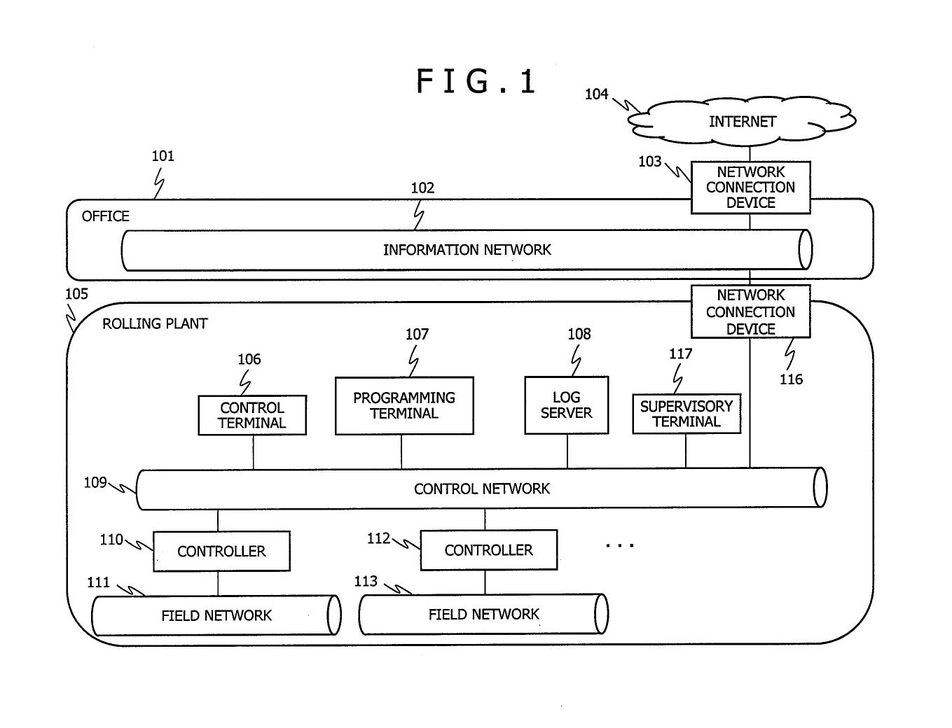

An overall structural diagram of a control system pertaining to an embodiment of the present invention is depicted in FIG. 1. In the present embodiment, as an example of a control system, the control system for a rolling plant 105 is assumed and described. However, such a control system may be for a thermal power plant, an atomic power plant, a wind power plant, a hydropower plant, a water supply and sewerage system, an oil plant, a chemical plant, a car manufacturing plant, a food manufacturing plant, an iron and steel manufacturing plant, and others. In FIG. 1, a control network 109 is laid inside the rolling plant 105. A variety of equipment operating inside the rolling plant 105 is connected to the control network 109. The control network 109 is connected to an information network 102 that is laid inside an office 101 via a network connection device 116. The information network 102 is a network to which information equipment for use in OA work is connected. To the information network 102, for example, PCs (Personal Computers), file servers, Web servers, mail servers, printers, etc. are connected. The information network 102 is connected to the Internet 104 via a network connection device 103. The network connection devices 103, 116 are devices that relay communication between devices connecting to each network; they may be routers, layer 3 switches, switching hubs, and the like.

To the control network 109, a control terminal 106, a programming terminal 106, a log server 108, a supervisory terminal 117, and controllers (110, 112) are connected via the network connection device 116. Among the equipment connected to the control network 109, there must at least one controller (110, 112), but one or more other pieces of equipment may not exist. Equipment other than that mentioned may be connected to the control network. The control network 109 may be a wired network, a wireless network, or a wire and wireless hybrid network.

Topology of the control network 109 may be star topology, bus topology, ring topology, any other topology, or a combination thereof.

The control terminal 106 performs a task such as updating firmware of the controllers (110, 112) via the control network 109. Also, the control terminal 106 directs the controllers (110, 112) to execute a controlled process and cognizes the status of a controlled process. The control terminal 106 may cognize that controlled process status is “under maintenance”, for example, when it is performing a task such as updating the firmware of the controllers (110, 112). The control terminal 106 may cognize that controlled process status is “operating”, for example, when it has commanded the controllers (110, 112) to execute a controlled process. The control terminal 106 may cognize controlled process status by any other method.

The programming terminal 107 is a terminal that performs writing of a control program that is to run on the controllers (110, 112) into the controllers (110, 112) via the control network 109.

The log server 108 is a device that collects and records operating logs of the controllers (110, 112) via the control network 109. In response to a request from the supervisory terminal 117, the log server 108 transmits recorded operating logs to the supervisory terminal 117 via the control network 109.

The supervisory terminal 117 is a device that acquires log data by accessing the log server 108 via the control network 109 and supervises, inter alia, the operating statuses of the controllers (110, 112).

The controllers (110, 112) connect with field equipment such as actuators, motors, and sensors via field networks (111, 113). The field networks (111, 113) are networks through which the controllers (110, 112) control the field equipment. The field networks (111, 113) may be wired networks, wireless networks, or wire and wireless hybrid networks. As the standards of the field networks (111, 113), there are Profibus, Modbus, HART, WirelessHART, ISA100.11a, etc. Although the controllers (110, 112) connect with the field equipment via the field networks (111, 113) in the structural diagram of FIG. 1, the controllers may connect directly with the field equipment via an I/O (Input/Output) unit that the controllers (111, 113) have. Although each controller is connected to each field network as in the diagram, for example, a plurality of controllers may be connected to and share one field network.

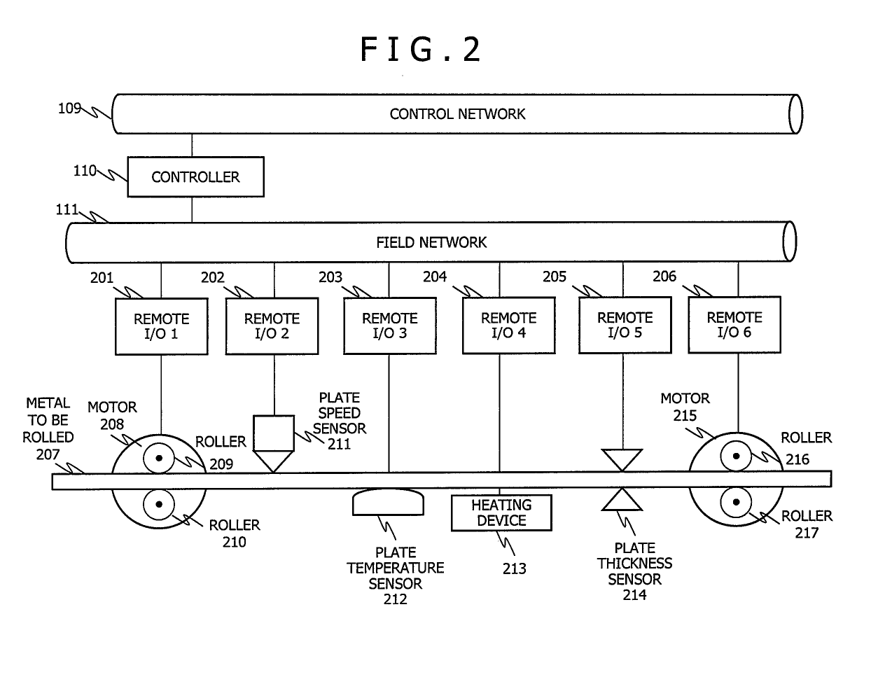

The structure of a field network 111 to which a controller 110 connects is depicted in FIG. 2.

In the rolling plant, controlled processes such as inputting metal to be rolled into a rolling line, metal rolling, and rolled product reeling are executed. The controller 110 is assumed to be a controller that controls execution of metal rolling as a controlled process.

To the field network 11, field equipment is connected via remote I/Os (201, 202, 203, 204, 205, 206). The remote I/Os (201, 202, 203, 204, 205, 206) input a command received from the controller via the field network (111) to the field equipment. Also, the remote I/Os (201, 202, 203, 204, 205, 206) transmit information which has been output by the field equipment to the controller 110 via the field network (111).

A motor 208 which connects with a remote I/O1 (201) is rotated in response to an input from the controller 110. With the rotation of the motor 208, rollers (209, 210) rotate, moving metal to be rolled 207 to flow through a rolling line. A plate speed sensor 211 which connects with a remote I/O2 (202) measures the moving speed of the metal to be rolled 207 and outputs a measurement result to the controller 110. A plate temperature sensor 212 which connects with a remote I/O3 (203) measures the temperature of the metal to be rolled 207 and outputs a measurement result to the controller 110. A heating device 213 which connects with a remote I/O4 (204) heats the metal to be rolled 207 by receiving an input from the controller 110. A plate thickness sensor 214 which connects with a remote I/O5 (205) measures the thickness of the metal to be rolled 207 and inputs a measurement result to the controller 110. A motor 215 which connects with a remote I/O6 (206) rotates rollers (216, 217) by receiving an input from the controller 110.

The controller 110 controls the rotating speeds of the motors (208, 215) and the heat output of the heating device 213, based on speed information measured by the plate speed sensor 211, temperature information measured by the plate temperature sensor 212, and plate thickness information measured by the plate thickness sensor 214.

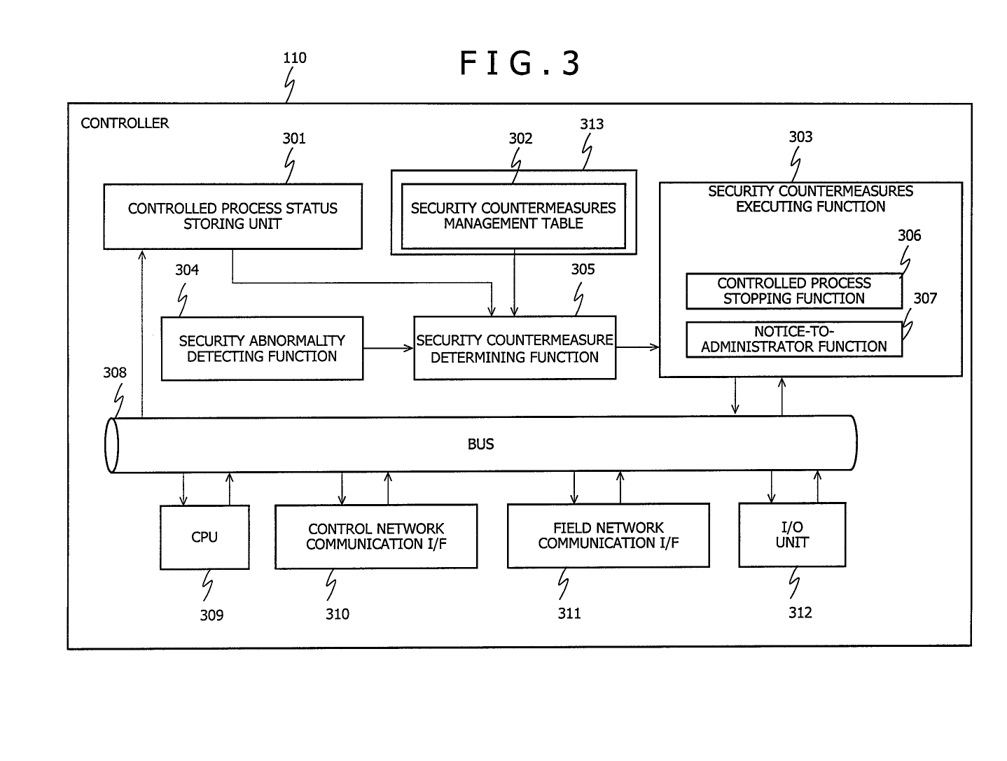

A functional block diagram of the controller 110 in the first embodiment of the present invention is depicted in FIG. 3. The controller 110 is comprised of a controlled process status storing unit 301, a security countermeasures management table storing unit 313, a security countermeasure executing function 303, a controlled process stopping function 306, a notice-to-administrator function 307, a bus 308, a CPU 309, a control network communication I/F 310, a field network communication I/F 311, and an I/O unit 312.

The controlled process status storing unit 301 receives a notification of the current status of a controlled process in the control system and stores the status. The current status of a controlled process in the control system stored on the controlled process status storing unit 301 is referenced by a security countermeasure determining function 305. In the present embodiment, the control terminal 106 is assumed to notify the controller 110 of the status of a controlled process. The controlled process status storing unit 301 receives the current status of a controlled process from the control terminal 106 via the control network 109, control network communication I/F 310, and bus 308. The controlled process status storing unit 301 may estimate the current status of a controlled process from the status of the I/O unit 312. The controlled process status storing unit 301 may estimate that the controlled process status is “operating”, for example, if values that are stored in the I/O unit 312 change frequently. The controlled process status storing unit 301 may estimate that the controlled process status is “under maintenance”, for example, if values that are stored in the I/O unit 312 have not been updated for a certain period of time. The controlled process status storing unit 301 may estimate the current status of a controlled process from the status of the remote I/Os (201, 202, 203, 204, 205, 206) connecting to the field network ill. The controlled process status storing unit 301 can estimate that the controlled process status is “operating”, for example, if values that are stored in the remote I/Os (201, 202, 203, 204, 205, 206) change frequently. The controlled process status storing unit 301 can estimate that the controlled process status is “under maintenance”, for example, if values that are stored in the remote I/Os (201, 202, 203, 204, 205, 206) have not been updated for a certain period of time. The controlled process status storing unit 301 may acquire the current status of a controlled process by any other method.

The security countermeasures management table storing unit 313 stores a security countermeasures management table 302 associating controlled process statuses and security countermeasures, one of which is to be executed in case of a security abnormality detected in each controlled process status. The controlled process status storing unit 301 and the security countermeasures management table storing unit 313 may be combined into a single storing unit.

The security countermeasure executing function 303 executes a security countermeasure, once a security abnormality has been detected. The security countermeasure executing function 303 has the controlled process stopping function 306 and the notice-to-administrator function 307 as security countermeasure functions. The security countermeasure executing function 303 may have other security countermeasure functions such as a communication I/F deactivating function.

A security abnormality detecting function 304 detects a security abnormality such as virus infection, DoS (Denial of Service) attack, or control program rewriting and notifies the security countermeasure determining function 305 of the detected security abnormality. Upon receiving a security abnormality notification from the security abnormality detecting function 304, the security countermeasure determining function 305 acquires the current status of a controlled process stored on the controlled process status storing unit 301. The security countermeasure determining function 305 refers to the security countermeasures management table 302, acquires a security countermeasure associated with the current process status acquired from the controlled process status storing unit 301 and notifies the security countermeasure executing function 303 of the security countermeasure. The security countermeasure executing function 303 executes the security countermeasure notified from the security countermeasure determining function 305.

The CPU 309, control network communication I/F 310, field network communication I/F 311, and I/O unit 312 transmit/receive a signal to/from one another via the bus 309.

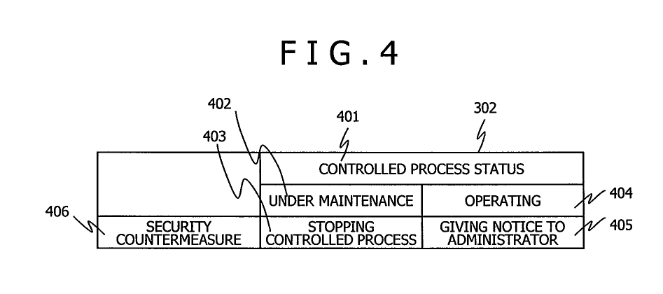

An example of a structure of the security countermeasures management table 302 is presented in FIG. 4. In case a security abnormality has been detected when controlled process status 401 is under maintenance 402, stopping the controlled process 403 is executed as a security countermeasure 406. In case a security abnormality has been detected when controlled process status 401 is operating 404, giving notice to administrator 405 is executed as a security countermeasure 406. Stopping the controlled process 403 is stopping the controlled process that is now executed by the controller 110. In the case of the present embodiment, the security countermeasure executing function 303 is to stop the operation of the motor 208 and the heating device 213. In the case of giving notice to administrator 405, the security countermeasure executing function 303 sends a notification that a security abnormality has occurred to the control terminal 106 operated by the administrator of the control system, via the control network communication I/F 310 and the control network 109. Other security countermeasures may be registered in the security countermeasures management table 302.

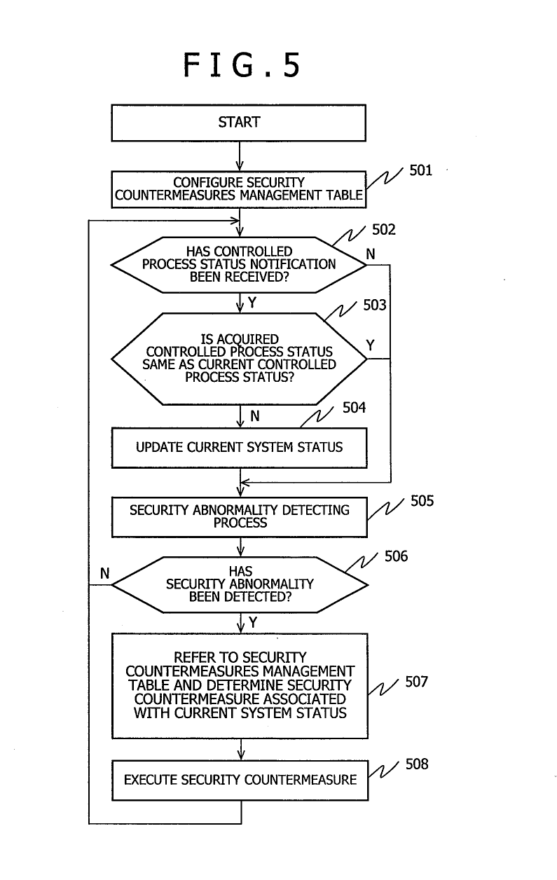

An operation flow diagram of the controller 110 is presented in FIG. 5. The controller 110 first configures the security countermeasures management table (501). The security countermeasures management table 302 may be configured in such a way that the controller reads in a configuration file when the controller is booted. The security countermeasures management table may be configured from the control terminal 106 via the control network 109. The security countermeasures management table 302 may be configured by any other method. Then, the controller 110 checks whether or not a notification of the current status of a controlled process has been received from the control terminal 106 (502). If a notification of controlled process status has not been received, the process goes to step 505. If a notification of controlled process status has been received, a check is made as to whether or not the acquired controlled process status is the same as the controlled process status stored on the controlled process status storing unit 301 (503). If the acquired controlled process status is the same as the controlled process status stored on the controlled process status storing unit 301, the process goes to step 505. If the acquired controlled process status is different from the controlled process status stored on the controlled process status storing unit 301, the controlled process status stored on the controlled process status storing unit 301 is updated to the acquired controlled process status (504). Then, a security abnormality detecting process is executed (505) and a check is made as to whether a security abnormality has been detected (506). If no security abnormality has been detected, the process goes to step 502. If a security abnormality has been detected, the security countermeasure determining function 305 refers to the security countermeasures management table 302, determines a security countermeasure associated with the current system status, and notifies the security countermeasure executing function 303 of the security countermeasure (507). Upon receiving the notification from the security countermeasure determining function, the security countermeasure executing function 508 executes the specified security countermeasure (508).

In case a security abnormality has been detected when the controlled process status is under maintenance, safety is ensured by stopping the controlled process as a security countermeasure. In case a security abnormality has been detected when the controlled process status is operating, by giving notice to the administrator, it becomes possible to consider a practical countermeasure against the security abnormality, while ensuring safety. According to the present embodiment, it becomes possible to ensure the safety of the control system even in case of security abnormality occurring by executing an appropriate security countermeasure depending on the controlled process status. The present embodiment is particularly effective for a sort of control system in which stopping a controlled process upon occurrence of security abnormality does not always lead to safety, as in a rolling plant.

### Second Embodiment

A controller of the present embodiment is characterized by determining a security countermeasure based on a combination of a particular security abnormality event occurring and a controlled process status.

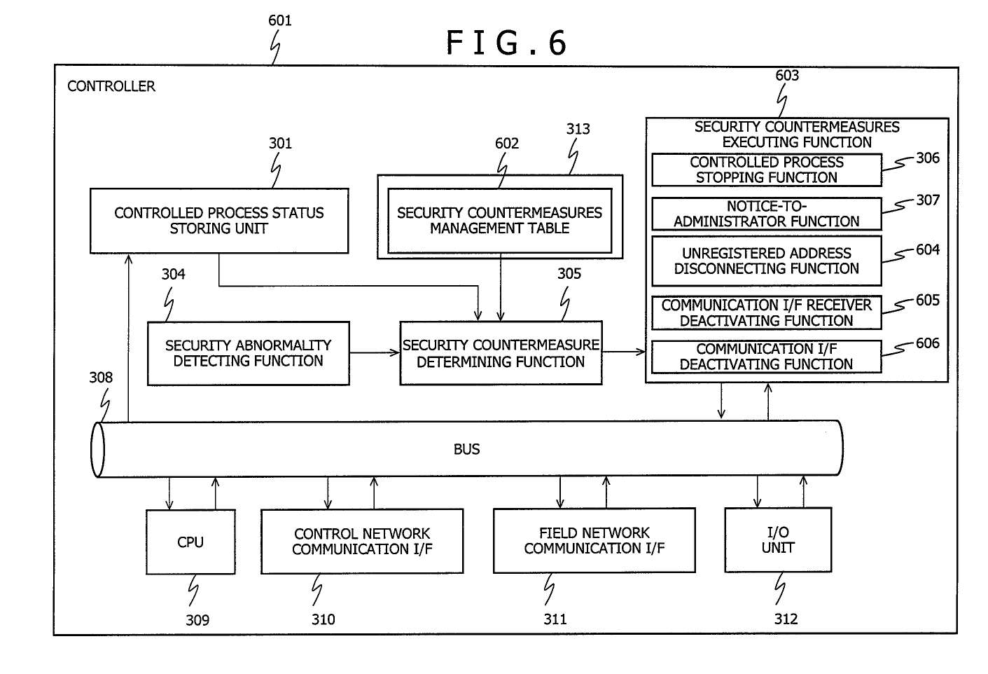

A controller 601 of the present embodiment is depicted in FIG. 6. In FIG. 6, parts that perform the same operations as the parts in FIG. 3 are assigned the same reference numerals.

A security countermeasures management table 602 manages security countermeasures methods based on a combination of controlled process status and a particular security abnormality event. A security countermeasure executing function 603 has, as practical security countermeasures, a controlled process stopping function 306, a notice-to-administrator function 307, an unregistered address disconnecting function 604, a communication I/F receiver deactivating function 605, and a communication I/F deactivating function 606. The unregistered address disconnecting function 604 disconnects a communication with an endpoint whose address is other than pre-registered addresses. The communication I/F receiver deactivating function 605 deactivates a receiver function of the control network communication I/F 310 and the field network communication I/F 311 and makes restriction to only a transmitter function. The communication I/F deactivating function 606 deactivates both transmitter and receiver functions of the control network communication I/F 310 and the field network communication I/F 311.

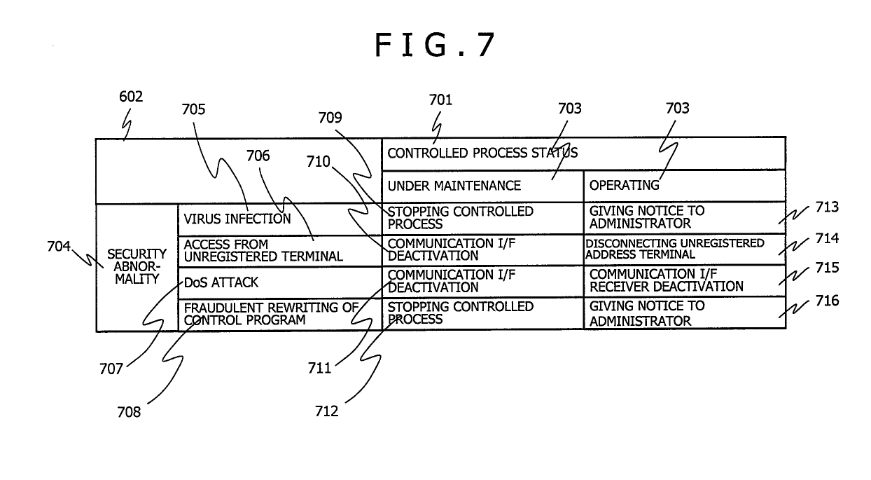

An example of a structure of the security countermeasures management table 602 is presented in FIG. 7. In case virus infection 705 has been detected as a security abnormality 704 when a controlled process status 701 is under maintenance 702, stopping the controlled process 709 is executed as a security countermeasure. In case the virus infection 705 has been detected as the security the abnormality 704 when the controlled process status 701 is operating 703, giving notice to an administrator 713 is executed as a security countermeasure. In case access from an unregistered terminal 706 has been detected as the security abnormality 704 when the controlled process status 701 is under maintenance 702, communication I/F deactivation 710 is executed as a security countermeasure. In case access from an unregistered terminal has been detected as the security abnormality 704 when the controlled process status 701 is operating 703, disconnecting an unregistered address terminal 714 is executed as a security countermeasure. In case DoS attack 707 has been detected as the security abnormality 704 when the controlled process status 701 is under maintenance 702, communication I/F deactivation 711 is executed as a security countermeasure. In case DoS attack 707 has been detected as the security abnormality 704 when the controlled process status 701 is operating 703, communication I/F receiver deactivation 715 is executed as a security countermeasure.

In case fraudulent rewriting of a control program 708 has been detected as the security abnormality 704 when the controlled process status 701 is under maintenance 702, stopping the controlled process 712 is executed as a security countermeasure. In case fraudulent rewriting of a control program 708 has been detected as the security abnormality 704 when the controlled process status 701 is operating 703, giving notice to administrator 713 is executed as a security countermeasure.

According to the present embodiment, it is possible to ensure the safety of a control system in which a plurality of typical events of security abnormality are possible to occur by determining a security countermeasure based on a combination of controlled process status and a particular security abnormality event occurring.

### Third Embodiment

In the first and second embodiments, it is assumed that controlled process status is either under maintenance or operating. However, in some control system, when a controlled process is operating, it is further classified into a plurality of statuses according to an ongoing operation of the controlled process. In the case of a control system in a rolling plant, as supposed here, in an initial phase after the control system is activated, it is assumed that heating a rolling line is only performed using the heating device 213 without allowing metal to be rolled 207 to flow through the rolling line. After the completion of heating the rolling line, it is assumed that metal to be rolled 207 is let to flow through the rolling line and metal rolling is performed. As discussed previously, when the controlled process is operating and metal rolling is performed as an ongoing process, stopping the process could cause hot steel to run off the rolling line and result in a serious calamity such as fire. On the other hand, when the controlled process is operating and heating the rolling line is performed as an ongoing process, even if the process has been stopped, there is no possibility that hot steel runs off the rolling line, resulting in a serious calamity such as fire. Therefore, in case a security abnormality has been detected when heating the rolling line is performed, stopping the controlled process should be executed, as this is thought to lead to ensuring the safety of the control system.

A controller of the present embodiment is characterized in that, when the controlled process status is operating, the controller determines a security countermeasure method in case of a security abnormality detected according to an ongoing process status in the operating status.

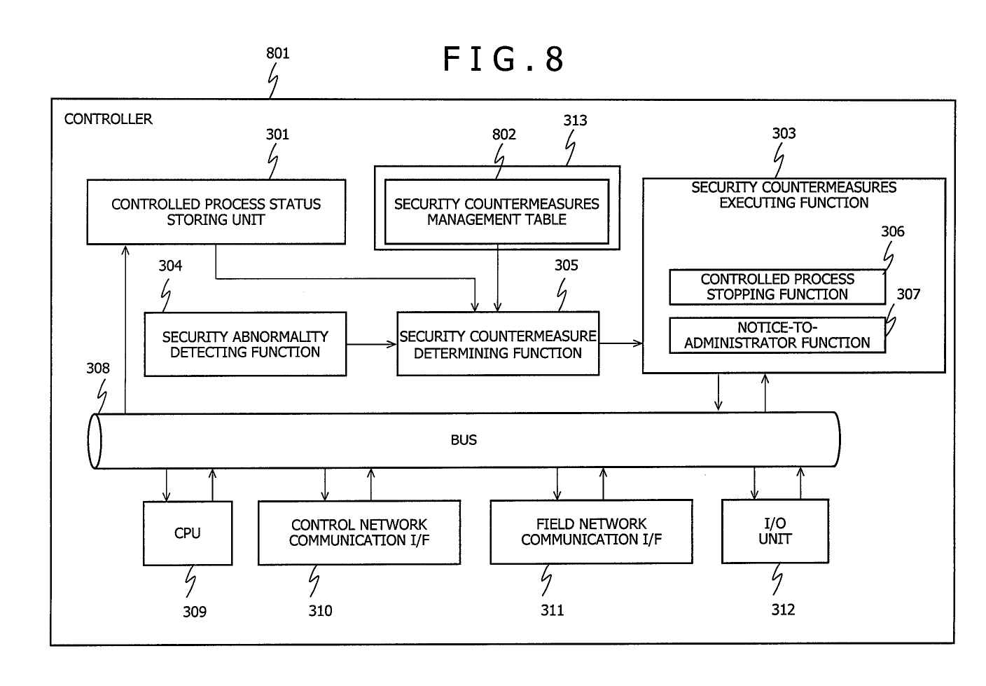

A controller 801 of the present embodiment is depicted in FIG. 8. In FIG. 8, parts that perform the same operations as the parts in FIG. 3 are assigned the same reference numerals. A security countermeasures management table 802 associates ongoing process statuses, when the controlled process status is operating, and security countermeasures in case of an abnormality detected.

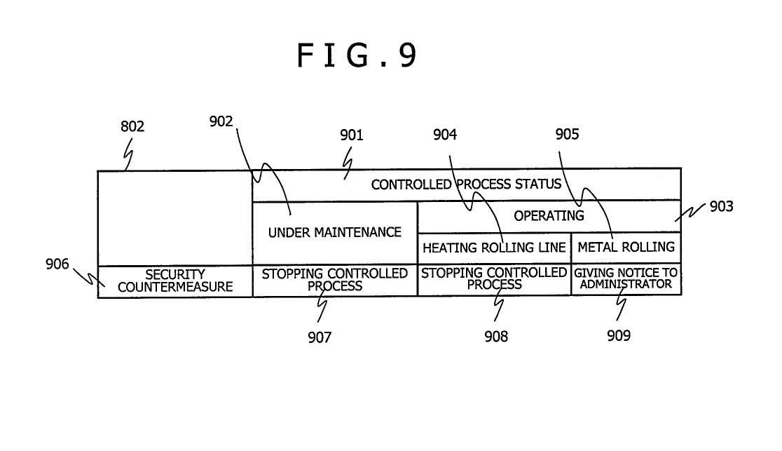

An example of a structure of the security countermeasures management table 802 is presented in FIG. 9. In case a security abnormality has been detected when a controlled process status 901 is under maintenance 902, stopping the controlled process 907 is executed as a security countermeasure 906. In case a security abnormality has been detected when the controlled process status 901 is operating 903 and an ongoing operation of the controlled process is heating the rolling line 904, stopping the controlled process 908 is executed as a security countermeasure. In case a security abnormality has been detected when the controlled process status 901 is operating 903 and an ongoing operation of the controlled process is metal rolling 905, giving notice to an administrator 909 is executed as a security countermeasure.

According to the present embodiment, it is possible to ensure the safety of a control system, even in case a security abnormality has been detected in the control system in which a process that is operating is classified into plural ones according to an ongoing operation of the controlled process.

### Fourth Embodiment

A controller of the present embodiment is characterized by determining a security countermeasure in case of a security abnormality detected, according to a combination of a particular security abnormality event occurring and an ongoing operation when the controlled process is operating.

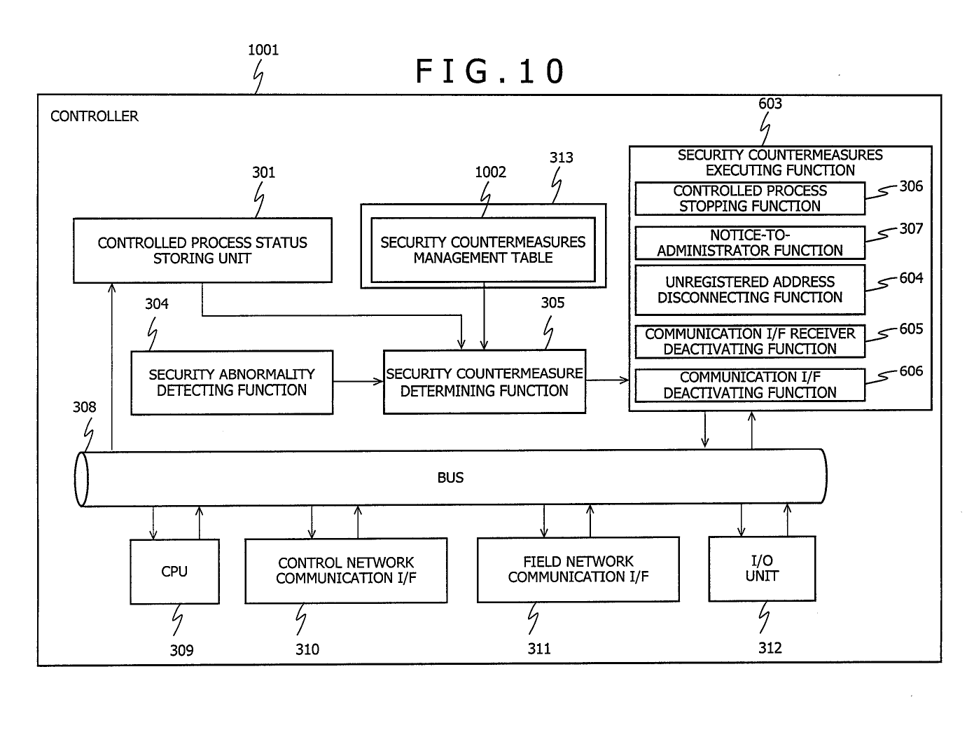

A controller 1001 of the present embodiment is depicted in FIG. 10. In FIG. 10, parts that perform the same operations as the parts in FIG. 6 are assigned the same reference numerals. A security countermeasures management table 1002 determines a security countermeasure in case of a security abnormality detected, according to a combination of a particular security abnormality event occurring and an ongoing operation when the controlled process is operating.

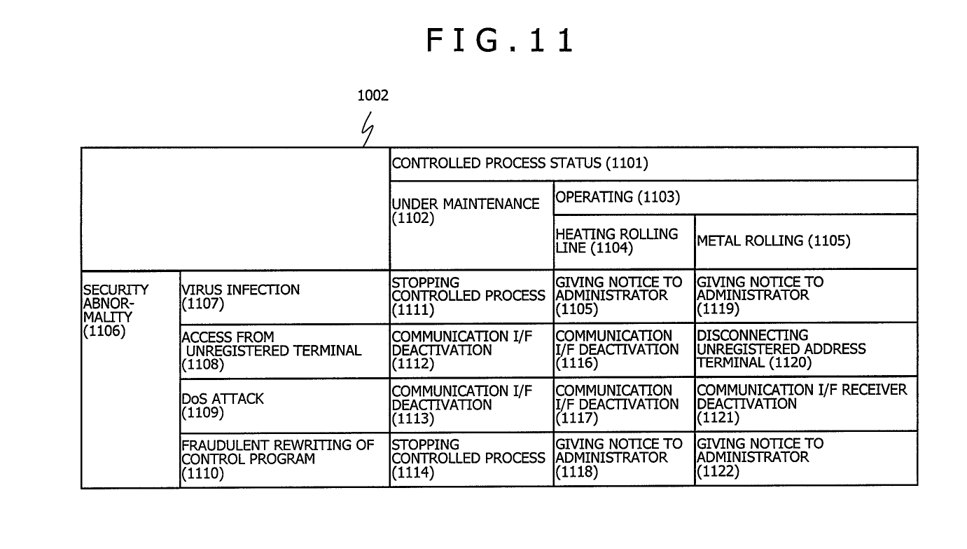

An example of a structure of the security countermeasures management table 1002 is presented in FIG. 11. In case virus infection 1107 has been detected as a security abnormality 1106 when a controlled process status 1101 is under maintenance 1102, stopping the controlled process 1111 is executed as a security countermeasure. In case the virus infection 1107 has been detected as the security abnormality 1106 when the controlled process status 1101 is operating 1103 and an ongoing process operation is heating the rolling line 1104, giving notice to an administrator 1115 is executed as a security countermeasure. In case the virus infection 1107 has been detected as the security abnormality 1106 when the controlled process status 1101 is operating 1103 and an ongoing process operation is metal rolling 1105, giving notice to an administrator 1119 is executed as a security countermeasure.

In case access from an unregistered terminal 1108 has been detected as the security abnormality 1106 when the controlled process status 1101 is under maintenance 1102, communication I/F deactivation 1112 is executed as a security countermeasure. In case access from an unregistered terminal 1108 has been detected as the security abnormality 1106 when the controlled process status 1101 is operating 1103 and an ongoing process operation is heating the rolling line 1104, communication I/F deactivation 1116 is executed as a security countermeasure. In case access from an unregistered terminal 1108 has been detected as the security abnormality 1106 when the controlled process status 1101 is operating 1103 and an ongoing process operation is metal rolling 1105, disconnecting the terminal 1120 is executed as a security countermeasure.

In case DoS attack 1109 has been detected as the security abnormality 1106 when the controlled process status 1101 is under maintenance 1102, communication I/F deactivation 1113 is executed as a security countermeasure. In case DoS attack 1109 has been detected as the security abnormality 1106 when the controlled process status 1101 is operating 1103 and an ongoing process operation is heating the rolling line 1104, communication I/F deactivation 1117 is executed as a security countermeasure. In case DoS attack 1109 has been detected as the security abnormality 1106 when the controlled process status 1101 is operating 1103 and an ongoing process operation is metal rolling 1105, communication I/F receiver deactivation 1121 is executed to disconnect a communication with an unregistered terminal as a security countermeasure.

In case fraudulent rewriting of a control program 1110 has been detected as the security abnormality 1106 when the controlled process status 1101 is under maintenance 1102, stopping the controlled process 1114 is executed as a security countermeasure. In case fraudulent rewriting of the control program 1110 has been detected as the security abnormality 1106 when the controlled process status 1101 is operating 1103 and an ongoing process operation is heating the rolling line 1104, giving notice to an administrator 1118 is executed as a security countermeasure. In case fraudulent rewriting of the control program 1110 has been detected as a security abnormality when the controlled process status 1101 is operating 1103 and an ongoing process operation is metal rolling 1105, giving notice to an administrator 1122 with an unregistered terminal is executed as a security countermeasure.

According to the present invention, it is possible to ensure the safety of a control system in which a process that is operating is classified into plural ones according to an ongoing operation of the controlled process and in which a plurality of types of security abnormality events are possible to occur.

### Fifth Embodiment

A plurality of types of controlled processes may be executed in a control system. Controlled processes in a control system inside a rolling plant include inputting metal to be rolled into a rolling line, metal rolling, etc.

In the present embodiment, an assumption is made of a control system in which a plurality of controlled processes exist and a different controller controls each controlled process. Each controller comprised in the control system of the present embodiment is characterized in that security countermeasure methods to be executed in case of a security abnormality detected differ depending on the type of a controlled process controlled by the controller.

The control system of the present embodiment is described with FIG. 1. A controller 110 inside the rolling plant 105 exerts control of metal rolling as a controlled process. A controller 112 exerts control of inputting metal to be rolled into a rolling line as a controlled process. The configuration of the controller 110 is as depicted in FIG. 3, which is described in the context of the first embodiment.

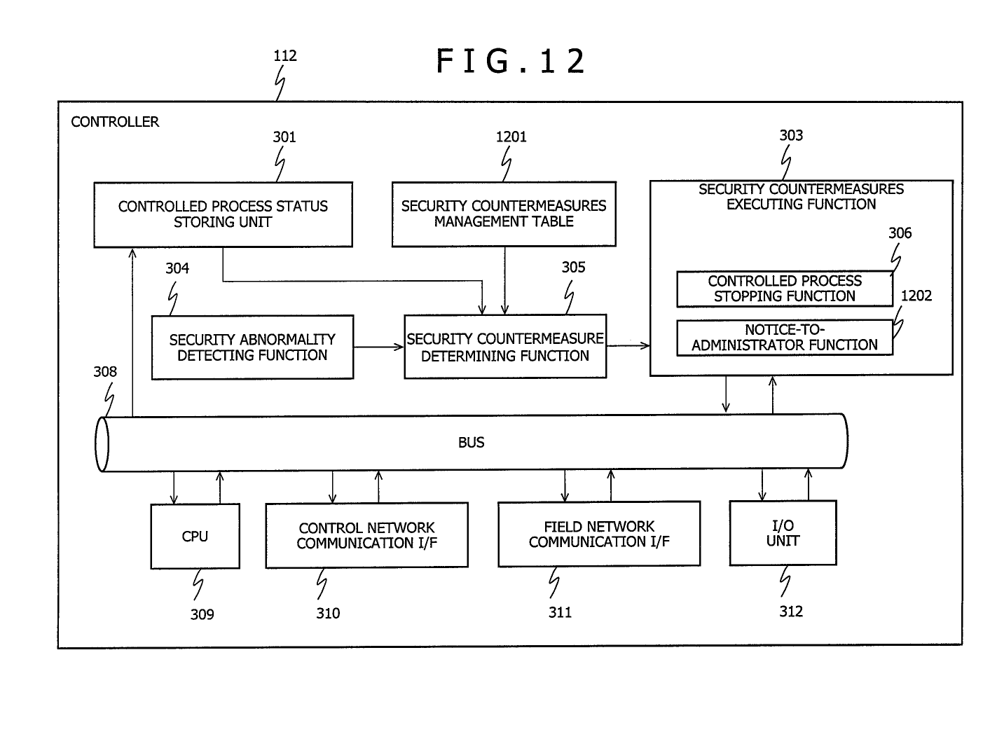

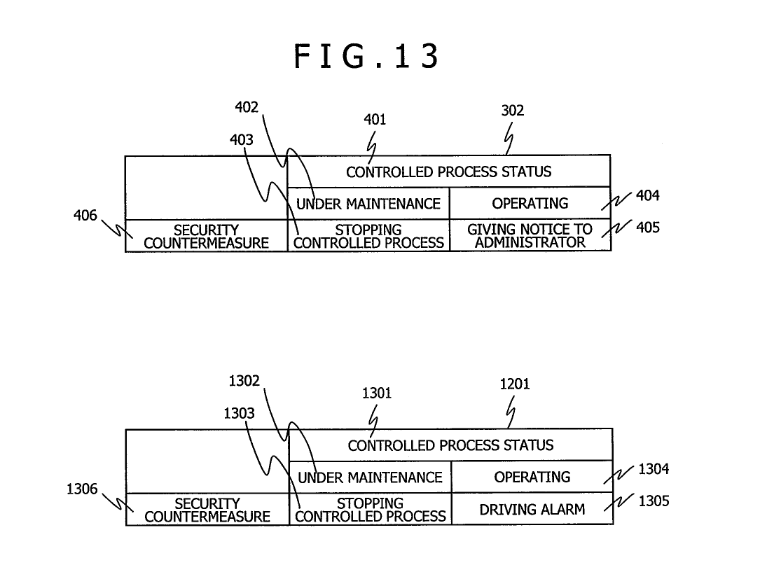

A configuration of the controller 112 is depicted in FIG. 12. In FIG. 12, parts that perform the same operations as the parts in FIG. 3 are assigned the same reference numerals. An alarm driving function 1202 is a function that sounds an alarm. A structure of a security countermeasures management table 302 of the controller 110 is presented in FIG. 13(a). In case a security abnormality has been detected when a controlled process status 401 is under maintenance 402, the controller 110 that controls metal rolling executes stopping the controlled process 403 as a security countermeasure 406. In case a security abnormality has been detected when the controlled process status 401 is operating 404, the controller 110 that controls metal rolling executes giving notice to administrator 405 as a security countermeasure 406.

A structure of a security countermeasures management table 1201 of the controller 112 is presented in FIG. 13(b). In case a security abnormality has been detected when a controlled process status 1301 is under maintenance 1302, the controller 112 that controls inputting metal to be rolled into a rolling line executes stopping the controlled process 1303 as a security countermeasure 1306. In case a security abnormality has been detected when the controlled process status 1301 is operating 1304, the controller 112 that controls inputting metal to be rolled into a rolling line executes driving the alarm 1305 as a security countermeasure 1306. A particular operation performed in a controlled process may require an operator to watch the controlled process in the vicinity of the field equipment and the controller. In case a security abnormality has occurred while such a controlled process is operating, activating an alarm by the controller to alert an operator being in its vicinity to the abnormality, rather than giving notice to the administrator terminal, would lead to ensuring safety.

The respective controllers (110, 112) of the present embodiment installed in different zones may have differently configured security countermeasures management tables adapted for each zone. For example, a controller installed in a zone where a controlled process that is important is executed and a controller installed in a zone where a controlled process that is less important is executed may have differently configured security countermeasures management tables.

The respective controllers (110, 112) of the present embodiment may determine a security countermeasure based on a combination of controlled process status and a particular security abnormality event occurring, as in the second embodiment.

The respective controllers (110, 112) of the present embodiment may execute a security countermeasure in case of a security abnormality detected according to an ongoing operation of the controlled process that is operating, as in the third embodiment.

The respective controllers (110, 112) of the present embodiment may determine a security countermeasure in case of a security abnormality detected, according to a combination of a particular security abnormality event occurring and an ongoing process operation when the controlled process is operating, as in the fourth embodiment.

According to the present embodiment, it is possible to ensure the safety of a control system even in case of a security abnormality occurred in the control system in which a plurality of types of controlled processes exist.

### Sixth Embodiment

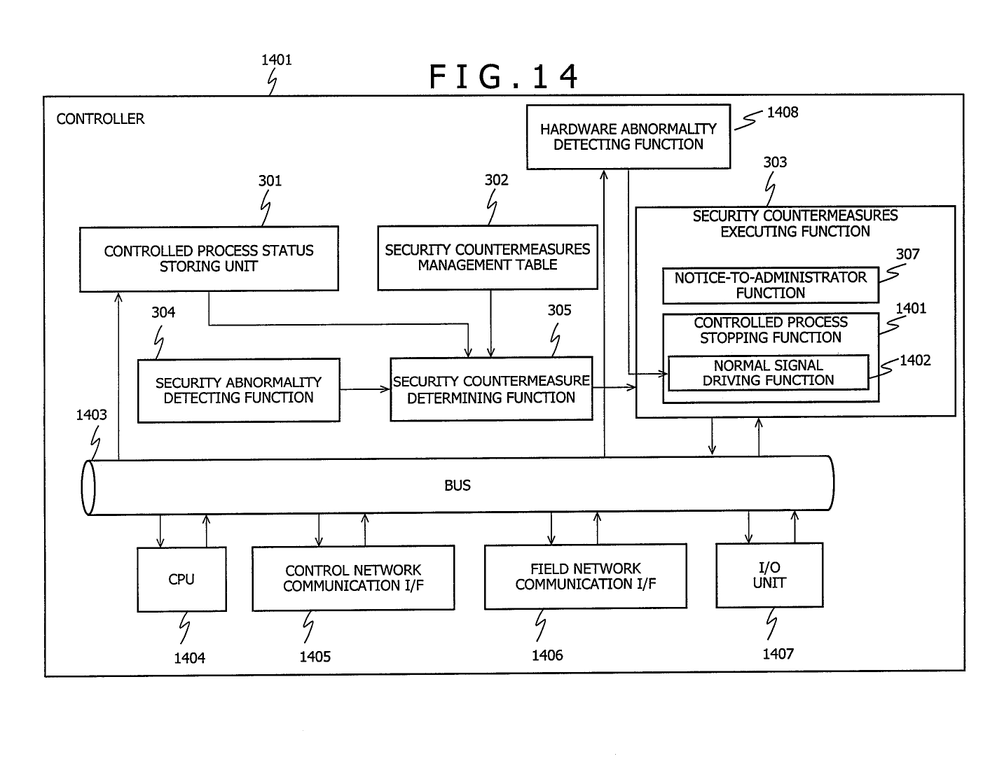

The controllers of the first through fifth embodiments are characterized by executing stopping the controlled process by being configured as described below. A configuration of a controller 1401 of the present embodiment is depicted in FIG. 14, where parts that perform the same operations as the parts in FIG. 3 are assigned the same reference numerals. A hardware abnormality detecting function 1408, when having detected a hardware abnormality of the CPU 1404, control network 1405, field network communication I/F, and I/O unit 1407, notifies a normal signal driving function 1402 that the hardware abnormality has been detected. The hardware abnormality detecting function 1408 may detect an abnormality of other hardware connecting to the bus 1403. A controlled process stopping function 1401, upon receiving a command to stop the controlled process from the security countermeasure determining function 305 or an abnormality detection signal from the hardware abnormality detecting function 1408, stops the controlled process by a method described below.

The normal signal driving function 1402 always transmits a normal signal onto the bus 1403, when no hardware abnormality or no security abnormality is detected within the controller. The normal signal driving function 1402, upon receiving an abnormality detection signal from the hardware abnormality detecting function 1408 or a command to stop the controlled process from the security countermeasure determining function 305, stops driving a normal signal that it always transmits onto the bus 1403. The CPU 1404, control network communication I/F 1405, field network communication I/F 1406, and I/O unit 1407 which connect to the bus 1403 always watch for presence/absence of a normal signal being transmitted on the bus 1402. When a normal signal is transmitted on the bus 1402, the CPU 1404, control network communication I/F 1405, field network communication I/F 1406, and I/O unit 1407 execute a controlled process as commanded. When a normal signal is not transmitted on the bus 1402, the CPU 1404, control network communication I/F 1405, field network communication I/F 1406, and I/O unit 1407 perform a preconfigured action to stop the controlled process. As an example of a preconfigured action to stop the controlled process, for example, the I/O unit 1407, upon cognizing that no normal signal is transmitted on the bus 1403, holds the last state of the I/O unit 1407 and does not accept any change even if receiving a write command from the CPU 1404 or the like.

According to the present embodiment, a security abnormality and a hardware abnormality are equally treated and it becomes possible to stop the control system safely even when a security abnormality has been detected.

### REFERENCE SIGNS LIST

101 . . . Office
102 . . . Information network
103, 116 . . . Network connection device
104 . . . Internet
105 . . . rolling plant
106 . . . Control terminal
107 . . . Programming terminal
108 . . . Log server
109 . . . Control network
110, 112, 601, 801, 1001, 1401 . . . Controller
111, 113 . . . Field Network
117 . . . Supervisory terminal
201, 202, 203, 204, 205, 206 . . . Remote I/O
207 . . . Metal to be rolled
208, 215 . . . Motor
209, 210, 216, 217 . . . Roller
211 . . . Plate speed sensor
212 . . . Plate temperature sensor
213 . . . Heating device
214 . . . Plate thickness sensor
301 . . . Controlled process status storing unit
302, 602, 802, 1002, 1201 . . . Security countermeasures management table
303, 603 . . . Security countermeasure executing function
304 . . . Security abnormality detecting function
305 . . . Security countermeasure determining function
306 . . . Controlled process stopping function
307 . . . Notice-to-administrator function
308, 1403 . . . Bus
309, 1404 . . . CPU
310, 1405 . . . Control network communication I/F
311, 1406 . . . Field network communication I/F
312, 1407 . . . I/O unit
604 . . . Unregistered address disconnecting function
605 . . . Communication I/F receiver deactivating function
606 . . . Communication I/F deactivating function
1202 . . . Alarm driving function
1402 . . . Normal signal driving function

1. A control system, comprising:
field equipment that executes a controlled process; and
a controller that controls execution of the controlled process by the field equipment,
wherein the controller includes:
a controlled process status storing unit that stores a status of a controlled process;
a security countermeasures management table storing unit that stores a security countermeasures management table associating controlled process statuses and security countermeasures methods;
a security abnormality detecting unit that detects a security abnormality in the control system;
a security countermeasure determining unit that determines one of the security countermeasures methods stored in the security countermeasures management table when a security abnormality in the control system has been detected by the security abnormality detecting unit;
a security countermeasure executing unit that executes the one of the security countermeasures methods determined by the security countermeasure determining unit;
a normal signal driving unit that transmits a normal signal onto a bus when neither a security abnormality nor a hardware abnormality is detected and stops transmitting the normal signal when either a security abnormality or a hardware abnormality is detected;
a hardware abnormality detecting unit that detects a hardware abnormality and notifies the normal signal driving unit of the hardware abnormality, when detected;
a controlled process stopping unit that stops a controlled process in response to a detected security abnormality detected by the security countermeasure determining unit and notifies the normal signal driving unit of the detected security abnormality; and
one or more hardware units connected to the bus that are configured to constantly detect a presence/absence of the normal signal on the bus and perform a preconfigured action upon having detected stop of the normal signal.

2. The control system according to claim 1,
wherein the security countermeasure determining unit determines the one of the security countermeasures methods that is associated with a controlled process status stored in the security countermeasures management table when the security abnormality has been detected.

3. The control system according to claim 1,
wherein the security countermeasures management table further associates the security countermeasures methods with predetermined security abnormality events, and
the security countermeasure determining unit determines the one of the security countermeasures methods that is associated with a controlled process status when one of the predetermined security abnormality events has been detected.

4. The control system according to claim 1,
wherein the controlled process statuses stored in the security countermeasures management table are controlled process statuses classified for each type of controlled process.

5. The control system according to claim 1,
wherein the control system comprises two or more of the controllers and wherein the security countermeasures management table storing units of any two of the controllers respectively hold the security countermeasures management tables having different contents.

6. (canceled)

7. A control method for use in a control system including field equipment that executes a controlled process and a controller that controls execution of a controlled process by the field equipment, the controller executing steps of:
detecting a security abnormality in the control system;
determining and executing a security countermeasure method against the security abnormality based on a status of a controlled process when the security abnormality has been detected in the control system;
detecting a hardware abnormality and notifying the hardware abnormality, when detected;
notifying a security abnormality when responding to a command to stop the controlled process based on the security countermeasure method;
transmitting a normal signal onto a bus when neither a security abnormality nor a hardware abnormality is detected and stopping transmitting the normal signal onto the bus when either a security abnormality or a hardware abnormality is detected; and
connecting one or more hardware units to a bus and continuously detecting a presence/absence of the normal signal on the bus and performing a preconfigured action upon detecting a stop of the transmitting of the normal signal.

8. The control method according to claim 7,
wherein the controller has a security countermeasures management table associating controlled process statuses and security countermeasures methods, and
determining with the controller one of the security countermeasures methods associated with a controlled process status when a security abnormality has been detected to be executed against the detected security abnormality.

9. The control method according to claim 7,
wherein the security countermeasures management table further associates the security countermeasures methods with predetermined security abnormality events, and
determining with the controller one of the security countermeasures methods associated with a controlled process status when one of the predetermined security abnormality events has been detected as the security countermeasure method to be executed against the detected predetermined security abnormality event.

10. The control method according to claim 7,
further including classifying controlled process statuses for each type of controlled process stored in the security countermeasures management table.

11. A controller that controls execution of a controlled process by field equipment, comprising:
a controlled process status storing unit that stores a status of a controlled process;
a security countermeasures management table storing unit that stores a security countermeasures management table associating controlled process statuses and security countermeasures methods;
a security abnormality detecting unit that detects a security abnormality in a control system;
a security countermeasure determining unit that determines one of the security countermeasures methods stored in the security countermeasures management table when a security abnormality in the control system has been detected by the security abnormality detecting unit;
a security countermeasure executing unit that executes the one of the security countermeasures methods determined by the security countermeasure determining unit;
a normal signal driving unit that transmits a normal signal onto the bus when neither a security abnormality nor a hardware abnormality is detected and stops transmitting the normal signal when either a security abnormality or a hardware abnormality is detected;
a hardware abnormality detecting unit that detects a hardware abnormality and notifies the normal signal driving unit of the hardware abnormality, when detected;
a controlled process stopping unit that stops a controlled process in response to a detected security abnormality detected by the security countermeasure determining unit and notifies the normal signal driving unit of the detected security abnormality; and
one or more hardware units connected to the bus that are configured to constantly detect a presence/absence of the normal signal on the bus and perform a preconfigured action upon having detected stop of the normal signal.

12. The controller according to claim 11,
wherein the security countermeasure determining unit determines one of the security countermeasures methods that is associated with a controlled process status stored in the security countermeasures management table when the security abnormality has been detected.

13. The controller according to claim 11,
wherein the security countermeasures management table further associates the security countermeasures methods with predetermined security abnormality events, and
the security countermeasure determining unit determines one of the security countermeasures methods that is associated with a controlled process status when one of the predetermined security abnormality events is detected.

14. The controller according to claim 11,
wherein the controlled process statuses stored in the security countermeasures management table are controlled process statuses classified for each type of controlled process.

15. The controller according to claim 11,
wherein for at least any two of said controllers, the security countermeasures management table storing units of the any two of said controllers respectively hold the security countermeasures management tables having different contents.
